(19) United States
(12) Patent Application Publication
(10) Pub. No.: US 2015/0122073 A1
(43) Pub. Date: May 7, 2015

(54) SPINAL COLUMN FOR A HUMANOID ROBOT

(71) Applicant: ALDEBARAN ROBOTICS, PARIS (FR)

(72) Inventor: Bruno Maisonnier, PARIS (FR)

(21) Appl. No.: 14/404,908

(22) PCT Filed: May 13, 2013
(86) PCT No.: PCT/EP2013/061224

§ 371 Date: Dec. 1, 2014

(30) Foreign Application Priority Data
Jun. 1, 2012 (FR) 1255078

(51) Int. Cl. B25J 9/00; B25J 17/00; B25J 18/06

(52) U.S. Cl. CPC B25J 9/0006; B25J 18/06; B25J 17/00
USPC 74/490.05

(57) ABSTRACT

A spinal column for a humanoid robot comprises a lower base to be fixed to a pelvis of the robot and an upper base to be fixed to a neck of the robot, the spinal column allowing two rotations of the upper base with respect to the lower base, a first being about a sagittal axis and a second being about a transverse axis. The column comprises a flexible rod and linear actuators, the rod being inset at a first of its ends at a point in a first of the bases and at least guided at a point in a second of the bases, the actuators both being anchored between the two bases at anchor points. For each of the bases, the anchor points of the two actuators and the point of insetting or guidance of the rod are distant.

The invention relates to a spinal column for a humanoid robot.

The human spinal column is the part of the human body that has the greatest number of joints. Each of these joints has five to six degrees of freedom. Numerous attempts have been made in humanoid robots to mimic human functionalities as closely as possible.

Conventionally, attempts have been made in robots to reproduce several vertebrae of the human spinal column by arranging several joints in series and motorizing each of these joints. In order to mimic a human spinal column as closely as possible, it is necessary to provide a large number of joints, and this increases the complexity of the robot both in terms of the number of independent actuators to be provided and in terms of the control of these various joint actuators that have to be operated in a coordinated fashion.

The invention seeks to provide a flexible spinal column with two degrees of freedom to rotate about two horizontal axes. A third rotation about a vertical axis is not employed in the spinal column according to the invention. This last rotation is advantageously achieved by a neck of the robot, which neck is assembled at the top of the spinal column. This spinal column remits only the main movements of a human spinal column so as to simplify production thereof. The flexibility of the column allows a monotonous curvature, which means a curvature distributed all along the spine as well as a small offset when one of the rotations is effected.

To this end, the subject of the invention is a spinal column for a humanoid robot, the column comprising a lower base intended to be fixed to a pelvis of the robot and an upper base intended to be fixed to a neck of the robot, the spinal column allowing two rotations of the upper base with respect to the lower base, a first of the rotations being about a sagittal axis and a second of the rotations being about a transverse axis of the column, characterized in that it further comprises a flexible rod and linear actuators, the rod being inset at a first of its ends at a point in a first of the bases and at least guided at a point in a second of the bases, the actuators both being anchored between the two bases at anchor points, and in that for each of the bases, the anchor points of the two actuators and the point of insetting or guidance of the rod are distant.

The invention will be better understood, and other advantages will become more clearly apparent, from reading the detailed description of one embodiment given by way of example, which description is illustrated by the attached drawing in which:

FIGS. 1 to 4 schematically depict a humanoid robot using a spinal column according to the invention;

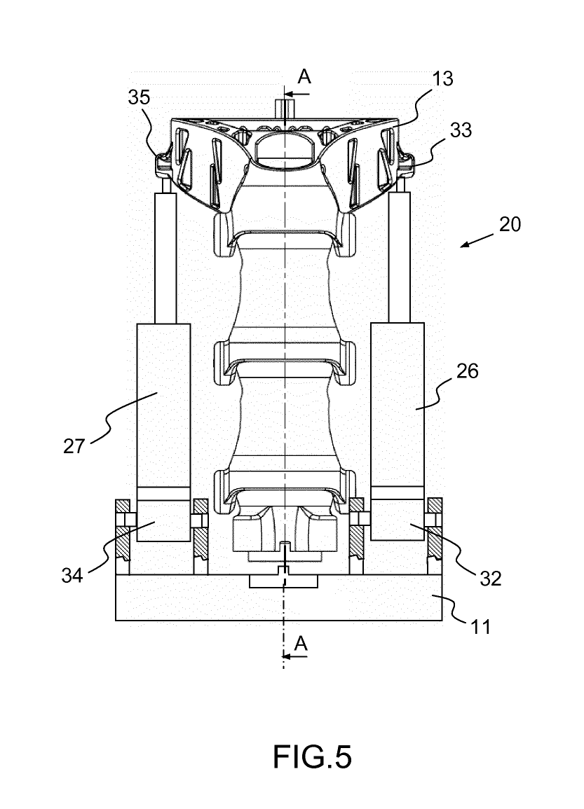

FIGS. 5 to 7 depict one embodiment of a spinal column according to the invention in greater detail.

For the sake of clarity, in the various figures the same elements bear the same references.

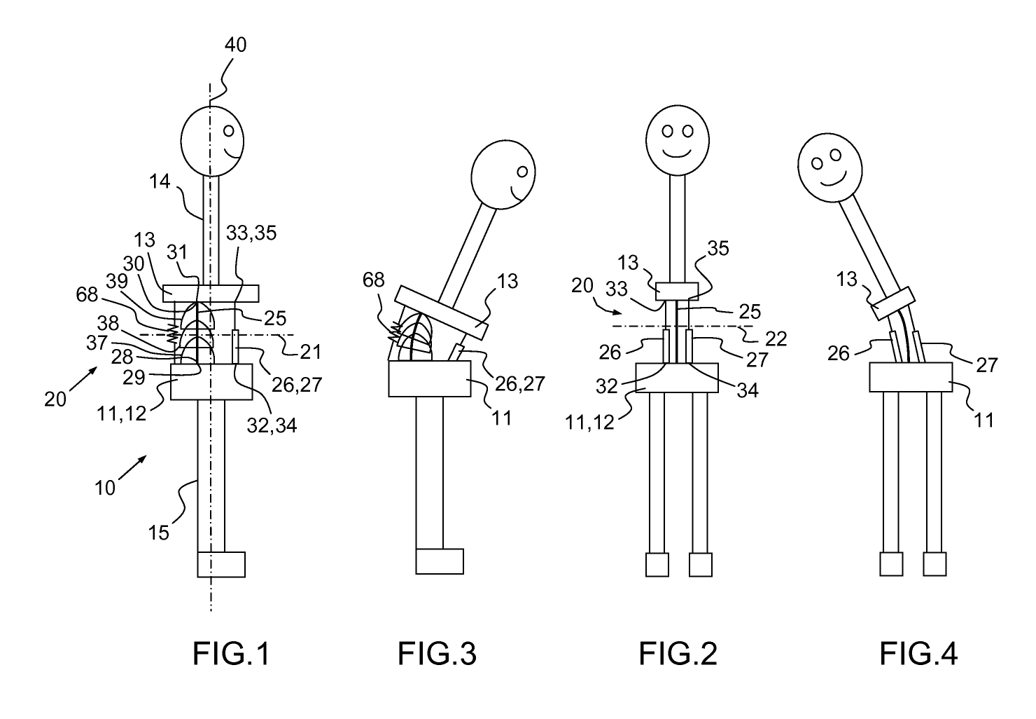

FIG. 1 schematically depicts a humanoid robot 10 viewed in profile and FIG. 2 depicts this same robot viewed face-on. The robot 10 comprises a lower base 11 intended to be fixed to a pelvis 12 of the robot 10 and an upper base 13 intended to be fixed to a neck 14 of the robot 10. Because the lower base 11 and the pelvis 12 are rigidly joined together, they are depicted as one and the same block. The pelvis 12 is articulated to legs 15 of the robot 10. A spinal column 20 connects the two bases 11 and 13. The spinal column 20 allows two rotations of the upper base 13 with respect to the lower base 11. A first of the rotations is about a sagittal axis 21 of the spinal column 20 and a second rotation is about a transverse axis 22 of the spinal column 20.

FIG. 3 depicts in profile the robot 10 in which the upper base 11 has undergone a rotation about the transverse axis 22 and is inclined forward. FIG. 4 depicts face-on the robot 10 in which the upper base 11 has undergone a rotation about the sagittal axis 21 and is inclined to one of its sides. The two rotations may, of course, be combined.

According to the invention, the spinal column 20 comprises a flexible rod 25 and two linear actuators 26 and 27. The rod 25 forms a beam inset at a first end 28 at a point 29 of the lower base 11 and guided or inset at a second end 30 at a point 31 of the upper base 13. As the upper base 13 rotates, the rod 25 bends. The actuators 26 and 27 are both anchored between the two bases 11 and 13 at anchor points distant from the point of insetting of the rod 25. The actuator 26 is anchored in the lower base 11 at the point 32 and in the upper base 13 at the point 33. The actuator 27 is anchored in the lower base 11 at the point 34 and in the upper base 13 at the point 35.

The linear actuators 26 and 27 are advantageously double-acting linear actuating cylinders. The anchor points 32 to 35 are formed by ball joints.

The spinal column 20 advantageously comprises at least pronged ball joints connected in series between the two bases 11 and 13. In the example depicted, the spinal column 20 comprises three pronged ball joints 37, 38 and 39. A pronged ball joint is a connection with two degrees of freedom in rotation. By comparison with a conventional ball joint that has three degrees of freedom, the prongs of the joint block the third rotation. All that remains are the rotation about the sagittal axis 21 and the rotation about the transverse axis 22. Rotation about a vertical axis 40 of the spinal column 20 is blocked. By preventing the ball joints from rotating about a vertical axis, the rod 25 does not experience any torsion but only bending. The naming of the various axes 21, 22 and 40 apply equally to the spinal column 20 and to the robot 10 when the latter is standing vertically. In practice, notably when the robot 10 is moving around, the axes 21, 22 and 40 are likely to experience a change in their orientation. For the sake of convenience, the orientation of these axes may be defined with respect to the lower base 11. Because the pronged ball joints are connected together in series, their axes of rotation can be defined for each of them. By convention, the axes of the three ball joints will be parallel when the spinal column 20 is vertical, or in other words when the rod 25 is not experiencing any bending.

In order to prevent the rod 25 from buckling, it is guided by each of the pronged ball joints 37, 38 and 39.

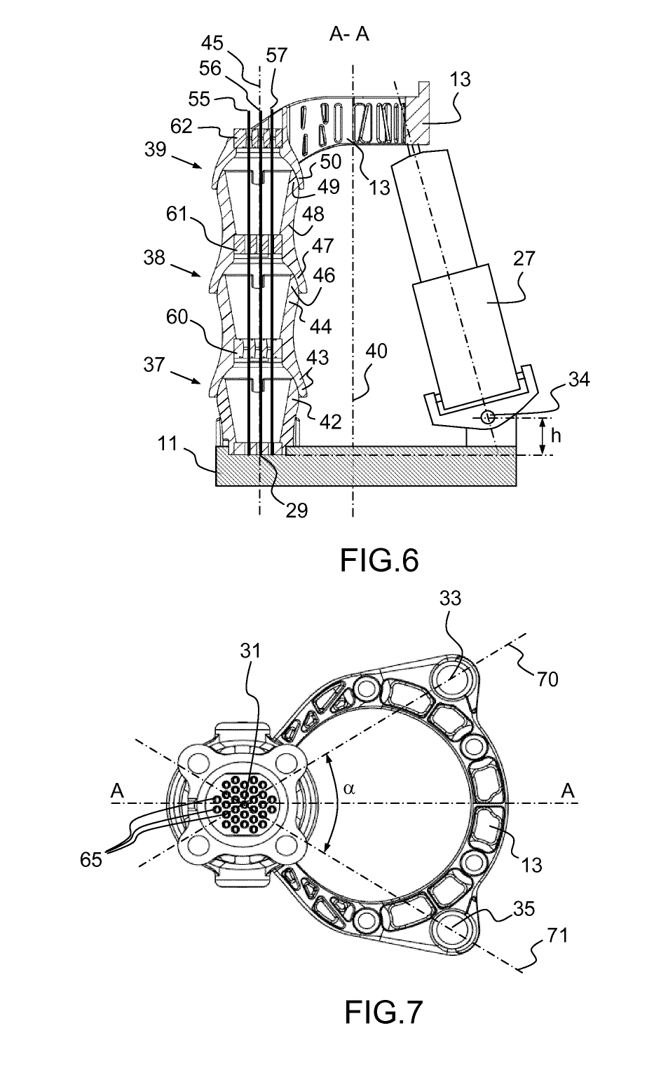

FIG. 5 depicts one embodiment of the spinal column 20 viewed from the back of the robot 10. FIG. 6 depicts the spinal column of FIG. 5 in section on a sagittal plane AA that forms a plane of symmetry of the spinal column 20. FIG. 7 depicts the spinal column 20 viewed from above.

FIGS. 5 to 7 show one embodiment of the pronged ball joints 37, 38 and 39. The pronged ball joint 37 comprises a dome 42 and a cavity 43, both of spherical shape and complementing one another. The dome 42 is secured to the lower base 11 and the cavity 43 is formed in the bottom part of a vertebra 44. The dome 42 and the cavity 43 have the same nominal diameter so as to slide one against the other in order to allow the rotations of the ball joint 37. Prongs belonging to the vertebra 44 can slide in grooves in the dome 42 so as to prevent the vertebra 44 from rotating about a vertical axis 45. Likewise, the ball joint 38 comprises a spherical dome 46, a spherical cavity 47 collaborating to perform the ball joint function and prongs able to run in grooves to block the rotation about the vertical axis 45. The dome 46 is connected to the top of the vertebra 44 and the cavity 47 at the bottom of a vertebra 48. Finally, the ball joint 39 comprises a spherical dome 49, a spherical cavity 50 collaborating to perform the ball joint function and prongs able to run in grooves to block the rotation about the vertical axis 45. The dome 49 is produced at the top of the vertebra 48 and the cavity 47 in the upper base 13 or in an attached component rigidly secured to the upper base 13. By convention, the vertical axis of the ball joints 38 and 39 is understood to mean when the spinal column 20 is vertical. In practice, the axis referred to as “vertical” of a ball joint inclines as a function of the rotation of the ball joint or joints connecting it to the lower base.

The angular travel of the rotations of each of the ball joints 37, 38 and 39 is not very great, typically of the order of 10 degrees or so. It is possible to hollow out the vertebrae 44 and 48 to allow the rod 25 to pass through the center of each of the vertebrae 44 and 48. The vertebrae 44 and 48 are pierced right through vertically to allow the rod 25 to be guided over its entire height. The rod 25 advantageously has a circular cross section so that it behaves identically in bending for any rotation of the spinal column 20.

Advantageously, the rod 25 comprises several strands running substantially parallel to one another. In FIG. 6, three strands 55, 56 and 57 can be seen. The strands are inset into the lower base 11 and guided by each vertebra 44 and 48. Making the rod 25 from several strands means that the tensile stresses in each of the strands as the rod 25 bends can be reduced.

The rod 25 can be set into the upper base 13. If pronged ball joints 37 to 39 are present, it is possible to leave the rod 25 a degree of freedom in translational movement along the vertical axis 45 with respect to the base 13. This is because the ball joints set the distance that separates the two bases 11 and 13 by being placed one atop the other. The rod 25 or the strands of which it is made can slide vertically with respect to the upper base 13. Guiding the rod 25 at one its ends also offers the advantage of avoiding a buildup of dimensions with excessively tight tolerances between the two bases 11 and 13. Thus, upon rotations of the pronged ball joints 37 to 39, the rod 25 is subjected only to pure bending. It is of course possible to reverse the insetting and guidance of the rod 25. In other words, the rod 25 may be set into the upper base 13 and guided in the lower base 11.

In order to guide the rod 25, in the embodiment in which the rod is made up of several strands, each of the pronged ball joints 37 to 39 advantageously comprises a grating substantially perpendicular to the main direction of the rod 25. When the spinal column 20 is vertical, the main direction of the rod 25 is the vertical axis 45. More specifically, the ball joint 37 comprises a grating 60 forming a top of the cavity 43, the ball joint 38 comprises a grating 61 forming a top of the cavity 47 and the ball joint 39 comprises a grating 62 forming a top of the cavity 50. Each of the gratings 60, 61 and 62 is pierced with several holes 65 distributed over the grating. Each of the strands of the rod 25 is guided by one of the holes 65 of each of the gratings. These holes 65 are clearly visible in the view from above in FIG. 7.

Upon movements of the spinal column 20, the strands are made to slide slightly in the holes 65. It is therefore important to provide a functional clearance between a hole 65 and the strand passing through it. The holes 65 and the strands may be cylindrical. The difference in diameter between the strand and the hole 65 must allow the strand to slide over the entire height of the corresponding grating. A local offset at the grating between the axis of the strand and the axis of the hole 65 needs to be permitted. That means that the diameter of the hole has to be enlarged, which is to the detriment of the guidance of the strand in its hole 65. In order to improve this guidance, each of the holes may have a bowed shape, midway up the height of the grating to which the hole 65 belongs, the height being measured in the main direction 45, each hole 65 widening toward its ends on each side of the bowed shape. A hyperboloid shape may for example be employed for each hole, the hyperboloid being of revolution about an axis parallel to the axis 45. More simply, a double-cone shape will already improve the guidance of the strands.

When the spinal column 20 is vertical, it is possible to offset the vertical axis on which the ball joints 37 to 39 are situated with respect to the vertical axis 40 of the robot 10 by considering that when the robot 10 is standing upright, the center of gravity of the upper part of the robot 10, which is the part situated above the upper base 13, is situated on the vertical axis 40. This situation reflects the human anatomy in which the spinal column is arranged along the back of the human body. When the robot is standing upright, the offsetting of the axes 40 and 45 normally means that the actuating cylinders have to permanently apply thrust in order to oppose the moment generated by this offset.

In order to avoid this permanent thrust, the spinal column 20 may comprise a spring 68 arranged between the two bases 11 and 13 such as to apply to the upper base 13 a force that tends to return it toward the rear of the robot 10. The spring 68 is clearly visible in FIGS. 1 and 3.

Another alternative that makes it possible to dispense with the spring is to apply a flexural preload to the rod 25 in a sagittal plane so that it applies to the upper base a force that tends to return it toward the rear of the robot 10 when the spinal column is vertical. When the rod 25 is made up of several strands, this preload may be obtained using the gratings 60, 61 and 62. Advantageously, the gratings 60, 61 and 62 are identical. Each grating comprises more holes 65 than there are strands, and the rod 25 is preloaded by passing the strands through holes in each grating. In the case of at least one strand, the guide holes for this strand in each of the gratings do not face each other, making this strand follow a curved path when the spinal column 20 is vertical, and thus applying a preload.

The lateral angular travel of the spinal column 20 is symmetric with respect to the sagittal plane AA and, advantageously, when the spinal column 20 is vertical, the anchor points 32 to 35 of the actuators 26 and 27 are situated on the bases 11 and 13 in a manner that is symmetric with respect to the sagittal plane AA passing through the rod 25.

When the rod 25 is formed of several strands, the point 29 of insetting is defined by convention as the center of a zone in which the strands are set into the lower base 11. The same is true of the point 31 of insetting or point of guidance of the rod 25 in the upper base 13.

It is advantageous to favor forward movements of the robot 10. To that end, for each of the bases, an angle α formed by two straight lines that meet at the point of insetting or guidance of the rod 25 and each of which passes through an anchor point of an actuator and has a value of less than 90°. FIG. 7 shows, for the upper base 13, a straight line 70 connecting the points 31 and 33 and a straight line 71 connecting the points 31 and 35. In a preferred embodiment, in order to mimic the human anatomy as closely as possible, the straight lines 70 and 71 make an angle α of 60°.

When the spinal column 20 is vertical, and still in order to favor the forward movements of the robot 10, the actuators 26 and 27 are advantageously inclined with respect to the vertical direction 40 such that the torque applied by each of the actuators 26 and 27 in order to accomplish the rotations is at a maximum in the middle of the angular travel of each of the rotations for a given force applied the actuator in question. This inclination is clearly visible in FIG. 6. When the two actuating cylinders 26 and 27 pull the upper base 13 downward, the actuating cylinders become more upright.

Advantageously, in order to reduce the space occupied by the spinal column 20, the points 32 and 34 of anchorage of the two actuators 26 and 27 on the lower base 11 are situated higher up than the point of insetting or guidance of the rod 25 in the lower base 11. It was seen earlier that the actuators 26 and 27 are anchored in the lower base by means of a ball joint. The anchor points 32 and 34 are defined at the center of rotation of the ball joint concerned. The anchor points 32 and 34 are vertically offset by a height h visible in FIG. 6, with respect to the point 29. As before, the vertical direction of offsetting is defined for a robot 10 standing upright. This heightwise offset makes it possible to reduce the space occupied by the spinal column 20 in its sagittal plane AA, which occupation of space is connected with the inclination of the actuators 26 and 27.

The rods 25 can be defined in such a way as to keep its moment of inertia about its longitudinal axis constant between its two ends 28 and 30. That axis is the vertical axis 45 when the spinal column 20 is vertical. This moment of inertia can be defined when the rod 25 is of one piece or when it is formed of several strands. In the case of a multi-strand embodiment, the overall moment of inertia of the rod 25 is the cumulative effect of the moments of inertia of the various strands combined as a function of the distance separating the strands. The rod 25 is, for example, formed of a one-piece mechanical component such as, for example, a bar of constant cross section running between the two ends 28 and 30. When the rod is formed of several strands, each is, for example, formed of a one-piece mechanical component likewise formed of a bar of constant cross section extending between the two ends 28 and 30. The one-piece component may be made from a homogeneous material, for example metallic material, or a composite material comprising for example fibers embedded in resin. The fibers extend along the entire length of the rod 25 between the two ends 28 and 30 thereof.

1. A spinal column for a humanoid robot, the column comprising a lower base intended to be fixed to a pelvis of the robot and an upper base intended to be fixed to a neck of the robot, the spinal column allowing two rotations of the upper base with respect to the lower base, a first of the rotations being about a sagittal axis and a second of the rotations being about a transverse axis of the column, further comprising a flexible rod and linear actuators, the rod being inset at a first of its ends at a point in a first of the bases and guided at a point in a second of the bases so as to be able to slide with respect to the second base, the actuators both being anchored between the two bases at anchor points, and wherein for each of the bases, the anchor points of the two actuators and the point of insetting or guidance of the rod are distant.

2. The spinal column as claimed in claim 1, wherein the linear actuators are double-acting linear actuating cylinders.

3. The spinal column as claimed in claim 1, comprising at least two pronged ball joints connected in series between the two bases, and wherein the rod is guided by each of the pronged ball joints.

4. The spinal column as claimed in claim 1, characterized in that the rod comprises several strands running substantially parallel to one another.

5. The spinal column as claimed in claim 3, each of the pronged ball joints comprising a grating substantially perpendicular to a main direction of the rod, wherein the grating is pierced with several holes distributed over the grating, and wherein each of the strands is guided by one of the holes of the grating.

6. The spinal column as claimed in claim 1, wherein each of the holes has a bowed shape midway up the height of the grating to which the hole belongs, the height being measured in the main direction, each hole widening toward its ends on each side of the bowed shape.

7. The spinal column as claimed in claim 1, wherein when the spinal column is vertical, the rod is preloaded in bending in a sagittal plane so as to apply to the upper base a force that tends to return it toward the rear of the robot.

8. The spinal column as claimed in claims 6, wherein the gratings of each of the pronged ball joints are identical, wherein each grating comprises more holes than there are strands, and wherein the rod is preloaded by passing the strands through holes in each grating, and wherein, in the case of at least one strand, the guide holes for this strand in each of the gratings do not face each other.

9. The spinal column as claimed in claim 1, comprising a spring arranged between the two bases such as to apply to the upper base a force that tends to return it toward the rear of the robot.

10. The spinal column as claimed in one of the claim 1, wherein when the spinal column is vertical, the anchor points of the actuators are situated on the bases in a manner that is symmetric with respect to a sagittal plane (AA) passing through the rod.

11. The spinal column as claimed in claim 10, wherein for each of the bases an angle formed by two straight lines that meet at a point of insetting or guidance of the rod and each of which passes through an anchor point of an actuator and has a value less than 90° and preferably equal to 60°.

12. The spinal column as claimed in claims, wherein when the spinal column is vertical, the actuators are inclined with respect to a vertical direction such that the torque applied by each of the actuators in order to accomplish the rotations is at a maximum in the middle of the angular travel of each of the rotations, for a given force applied the actuator in question.

13. The spinal column as claimed in claim 1, wherein the points of anchorage of the two actuators to the lower base are situated higher up than the point of insetting or guidance of the rod in the lower base.

14. The spinal column as claimed in claim 1, wherein the rod, between its two ends, maintains a constant moment of inertia about its longitudinal axis.
